(19) United States
(12) Patent Application Publication
(10) Pub. No.: US 2009/0027919 A1
(43) Pub. Date: Jan. 29, 2009

(54) BACKLIGHT MODULE

(75) Inventors: Hua-Te Feng, Hsinchu (TW); Jen-Hsien Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/964,009

(22) Filed: Dec. 25, 2007

(30) Foreign Application Priority Data
Jul. 25, 2007 (TW) 96127051

(51) Int. Cl. F21V 7/04

(52) U.S. Cl. 362/616

(57) ABSTRACT

A backlight module including a back plate, a reflection sheet, a light guiding plate, a reflector, and a first light source and a second light source is provided. The reflection sheet is disposed on the back plate, and one end of the reflection sheet is bent to form a lamp reflector. The light guiding plate is disposed on the reflection sheet, and has a first side and a corresponding second side. A first containing space is formed between the first side of the light guiding plate and the lamp reflector. The reflector is disposed at the second side of the light guide plate, and a second containing space is formed between the second side of the light guiding plate and the reflector. The first light source and the second light source are disposed within the first and the second containing space, respectively.

### CROSS-REFERENCE TO RELATED APPLICATION

This application claims the priority benefit of Taiwan application serial no. 96127051, filed on Jul. 25, 2007. The entirety of the above-mentioned patent application is hereby incorporated by reference herein and made a part of this specification.

### BACKGROUND OF THE INVENTION

1. Field of the Invention

The present invention relates to a backlight module. More particularly, the present invention relates to a backlight module, in which a reflection sheet is bent to form a lamp reflector adapted for reflecting light.

2. Description of Related Art

With the development of technologies, digital devices such as mobile phones, digital cameras, digital video cameras, notebooks and desktop computers have more convenience and become more multifunction and more elegant. During utilization of each of the digital devices, a display screen is an indispensable communication interface between a user and the digital device which is utilized because the user uses the aforementioned device more conveniently through the display screen. Recently, liquid crystal displays (LCDs) become popular in the market. However, since LCD panel has no luminescent function itself, a backlight module is required for providing a light source for the corresponding LCD panel, so as to achieve a display function of an LCD panel.

FIG. 1 is a cross-sectional view of a conventional backlight module. Referring to FIG. 1, the conventional backlight module 100 includes a back plate 110, a frame 120, a reflection sheet 130, a light guiding plate 140, an optical film set 150, light sources 160 disposed on a top side and a bottom side of the light guiding plate 140, and reflectors 170. Each of the reflectors 170 is composed of a metal substrate 172 and a reflective material layer 174 disposed on the surface of the metal substrate 172.

When the backlight module 100 is about to be assembled, first, the reflection sheet 130, the light guiding plate 140, the optical film set 150 and the frame 120 are sequentially disposed on the back plate 110. Next, the light sources 160 and the reflectors 170 are disposed on the top side and bottom side of the light guiding plate 140, and inserted in a containing space formed between the light guiding plate 140 and the back plate 110. A part of light emitted from the light sources 160 enters the light guiding plate 140 after reflected by the reflectors 170. Then, the light entering the light guiding plate 140 is refracted by the reflection sheet 130, and emits through the optical film set 150, so as to provide a uniform light source for the LCD panel (not shown).

As shown in FIG. 1, the metal substrate 172 of each of the reflectors 170 is made of metal material, resulting in the problems of high production cost and overweight. In addition, the number of components included in the aforementioned backlight module 100 is excessive, and the assembling time of the backlight module 100 is relatively long, which also increases the production cost.

FIG. 2 is a cross-sectional view of another conventional backlight module. Referring to FIG. 2, the backlight module 300 mainly includes a back plate 310, a frame 320, a reflection sheet 330, a light guiding plate 340, an optical film set 350 and light sources 360 disposed on a top side and a bottom side of the light guiding plate 340. A structure of the backlight module 300 is approximately the same as that of the backlight module 100 of FIG. 1, the difference between them is that both ends of the reflection sheet 330 of the backlight module 300 are bent to form the lamp reflectors 332 on both the top side and the bottom side of the light guiding plate 340, and the lamp reflectors 332 are used for containing the light sources 360.

However, as shown in FIG. 2, the bent top end of the reflection sheet 330 is deformed downwards due to the gravity. In addition, the reflection sheet 330 cannot smoothly attach to the light guiding plate 340 due to waving of the reflection sheet 330 during thermal expansion, and therefore a luminance of the backlight module 300 is affected. Moreover, the backlight module 300 may also have a problem of poor thermal dissipation.

### SUMMARY OF THE INVENTION

The present invention is directed to a backlight module, in which one end of a reflection sheet is bent to form a lamp reflector on a bottom side of a light guiding plate for containing a light source, and a reflector made of metal is disposed on a top side of the light guiding plate. The lamp reflector and the reflector are all used for containing the light sources. By such means, the problems occurred in the prior art, such as deformation and waving of the reflection sheet, decreasing of a luminance of the backlight module, and poor thermal dissipation due to bending both ends of the reflection sheet to form lamp reflectors on both sides of the light guiding plate are avoided.

Other advantages and objects of the present invention can be further comprehended through the technical features disclosed in the present invention.

According to an embodiment of the present invention, a backlight module including a back plate, a reflection sheet, a light guiding plate, a reflector, a first light source and a second light source is provided. The reflection sheet is disposed on the back plate, and one end of the reflection sheet is bent to form a lamp reflector. The light guiding plate is disposed on the reflection sheet, and has a first side and a corresponding second side. A first containing space is formed between the first side of the light guiding plate and the lamp reflector. The reflector is disposed at the second side of the light guide plate, and a second containing space is formed between the second side of the light guiding plate and the reflector. The reflector and the reflection sheet are separable. The first light source and the second light source are disposed within the first and the second containing space, respectively.

In the backlight module of the present invention, one end of the reflection sheet is bent to form the lamp reflector on the bottom side of the light guiding plate for containing one light source, and the reflector made of metal is disposed on the top side of the light guiding plate for containing the other light source. Comparing with a conventional backlight module of the relate art which requires to bend both ends of the reflection sheet to form the lamp reflectors located respectively on the top side and bottom side of the light guiding plate, the backlight module of the present invention which has been strictly tested under a high temperature and a high humidity environment has a better luminance performance and a better thermal dissipation effect, and deformation of the reflection sheet can be avoided according to a testing result.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a cross-sectional view of a conventional backlight module.

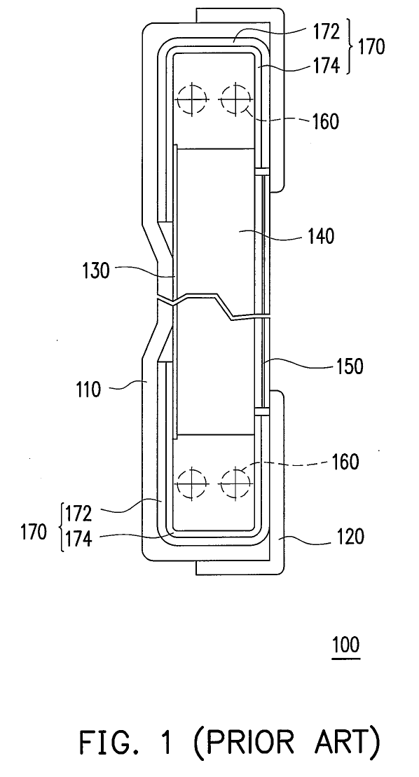

FIG. 2 is a cross-sectional view of another conventional backlight module.

FIG. 3 is a cross-sectional view of a backlight module according to an embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

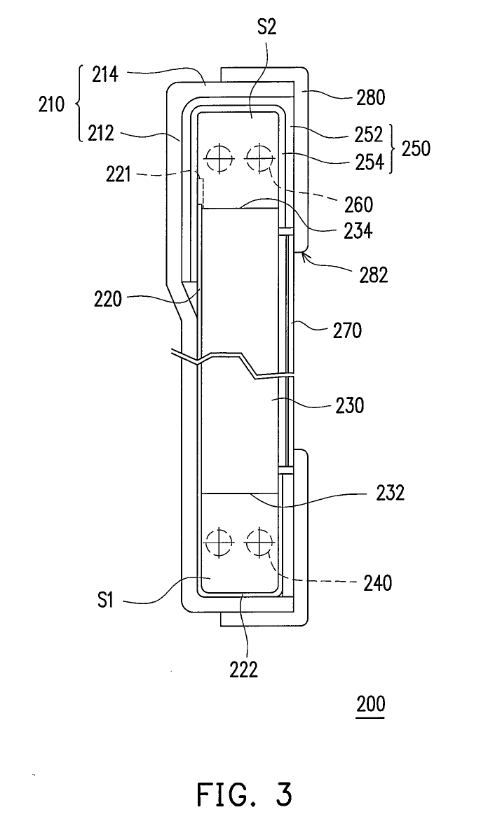

FIG. 3 is a cross-sectional view of a backlight module according to an embodiment of the present invention. Referring to FIG. 3, the backlight module 200 is a side-edge type backlight module. The backlight module 200 includes a back plate 210, a reflection sheet 220, a light guiding plate 230, a reflector 250, a first light source 240 and a second light source 260. Structure and connecting relation of the components of the backlight module 200 are described as follows with reference to the drawing.

The back plate 210 is a metal plate, and includes a base 212 and a sidewall 214 vertically connected to the base 212, so as to form a space for containing the reflection sheet 220, the light guiding plate 230 and the optical films (not shown). The reflection sheet 220 is disposed on the back plate 210 and is used for reflecting light beams (not shown) emitted from the light sources to the light guiding plate 230, so as to improve an illumination efficiency of the backlight module 200. One end of the reflection sheet 220 is bent to form a U-shaped lamp reflector 222, which is used for substituting a conventional reflector, so as to simplify the number of components and structure complexity of the backlight module 200. Moreover, since the material of the reflection sheet 220 is the same as that of the reflective material layer of the conventional reflector, the luminance of the backlight module 220 stays unchanged.

The light guiding plate 230 is disposed on the reflection sheet 220, and is capable of converting the light beams into a planar light source (not shown). The light guiding plate 230 has a first side 232 and a corresponding second side 234. A containing space S1 is formed between the first side 232 and the lamp reflector 222 for containing the first light source 240. In the present embodiment, the first light source 240 may be a cold cathode fluorescent lamp. However, it should be understand that the first light source 240 may also be a light emitting diode array, which is not limited by the present invention.

The reflector 250 is disposed at the second side 234 of the light guiding plate 230, and is also composed of a metal substrate 252 and a reflective material layer 254 disposed on the surface of the metal substrate 252. The reflector 250 and the reflection sheet 220 are separable, and a second containing space S2 is formed between the second side 234 of the light guiding plate 230 and the reflector 250 for containing the second light source 260. In the present embodiment, the second light source 260 may be the cold cathode fluorescent lamp. However, it should be understand that the second light source 260 may also be the light emitting diode array, which is not limited by the present invention.

Moreover, when the backlight module 200 works, since the hot air flows upwards, the temperature of the second light source 260 located at the top side of the light guiding plate 230 is greater than the temperature of the first light source 240 located at the bottom side of the light guiding plate 230. Therefore, a conventional reflector 250 is still used for reflecting the light beams emitted from the second light source 260, such that the metal substrate 252 of the reflector 250 is used for thermal dissipation to achieve a better thermal dissipation effect.

A design of bending one end of the reflection sheet 220 to form the lamp reflector 222 is also applied to the backlight module with a single incident light, besides the backlight module 200 with a design of bilateral incident light as shown in FIG. 3, so as to simplify the number of components and structure complexity of the backlight module.

In addition, to further improve an optical display quality of the backlight module 200, the backlight module 200 further includes an optical film set 270 disposed on the light guiding plate 230. The optical film set 270 includes at least one of a diffuser film, a prism sheet and a brightness enhanced film (BEF) or a combination thereof. To be specific, the diffuser film uniformly scatters the light beams emitted from the first light source 240 and the second light source 260, the prism sheet enhances a correctness of emitting direction of the light beams, and the brightness enhanced film improves a brightness of the backlight module 200.

Moreover, the backlight module 200 further includes a frame 280, and the frame 280 is assembled on the back plate 210 for fixing the reflection sheet 220, the light guiding plate 230, the optical film set 270, the first light source 240 and the second light source 260. The frame 280 has an opening 282 for exposing the light guiding plate 230, such that the light beams enter the corresponding LCD panel (not shown).

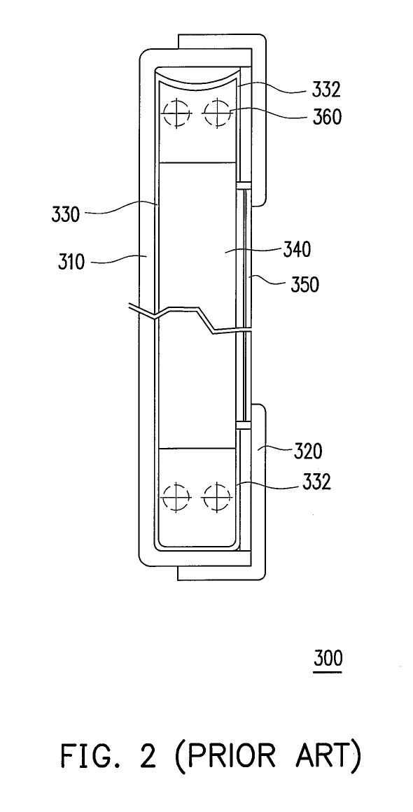

In order to make sure that the backlight module 200 of the present embodiment has a better performance, testing of the luminance and the deformation of the backlight module 200 of FIG. 3 and the backlight module 300 of FIG. 2 are performed under a high temperature and a high humidity environment, and the testing result is shown as follows:

TABLE ONE

| | | Average | |
|---|---|---|---|
| | | luminance of | |
| | Central | five central | Average |
| Structure | luminance | points | luminance |
| Backlight module | 5955 | 5377 | 5182 |
| 200 of FIG. 3 | | | |
| Backlight module | 6002 | 5348 | 5190 |
| 300 of FIG. 2 | | | |

TABLE TWO

| | | Attenuation of | |
|---|---|---|---|
| | Attenuation | average | |
| | of | luminance of | Attenuation of |
| | central | five central | average |
| Structure | luminance | points | luminance |
| Backlight module 200 of | 29% | 27% | 26% |
| FIG. 3 | | | |
| Backlight module 300 of | 32% | 31% | 30% |
| FIG. 2 | | | |

Initial luminance of the backlight module 200 of FIG. 3 and that of the backlight module 300 of FIG. 2 are shown in Table one. Variation of the luminance of the backlight module 200 of FIG. 3 and that of the backlight module 300 of FIG. 2 are shown in Table two after the backlight modules 200 and 300 are tested under a high temperature and a high humidity environment over 2000 hours. As shown in Table one, there is little difference of the central luminance between the two backlight modules 200 and 300 at the beginning. After the backlight modules 200 and 300 are tested under a high temperature and a high humidity environment over 2000 hours, attenuation of the central luminance of the backlight module 300 is greater than that of the backlight module 200.

TABLE THREE

| | Deformation of |
|---|---|
| Structure | the reflection sheet |
| Backlight module 200 of FIG. 3 | No |
| Backlight module 300 of FIG. 2 | Yes |

After the backlight modules 200 and 300 are tested under a high temperature and a high humidity environment over 2000 hours, deformation state of the reflection sheet of the backlight module 200 of FIG. 3 and that of the backlight module 300 of FIG. 2 are shown in Table three. As shown in FIG. 3, after the backlight modules 200 and 300 are tested under a high temperature and a high humidity environment over 2000 hours, both ends of the reflection sheet 330 of the backlight module 300 of FIG. 2 are closely attached to the light guiding plate. Therefore, the reflection sheet 330 cannot extend towards both sides during thermal expansion, which would cause a waving of the reflection sheet 330. On the other hand, the containing space S2 of the backlight module 200 provides an expansion space 221 for the top end of the reflection sheet 220, such that the reflection sheet 220 may extend towards the expansion space 221 during thermal expansion. Therefore, the luminance of the backlight module 200 stays unchanged since deformation and waving of the reflection sheet 220 during thermal expansion are avoided.

In summary, in the backlight module according to an embodiment of the present invention, one end of the reflection sheet disposed at the bottom side of the light guiding plate is bent to form the lamp reflector for containing one light source, and the reflector made of metal is disposed on the top side of the light guiding plate for containing the other light source Comparing with a conventional backlight module of the prior art which requires to bend both ends of the reflection sheet to form the lamp reflectors located respectively on both sides of the light guiding plate, the backlight module according to an embodiment of the present invention has a better luminance performance and a better thermal dissipation effect, and deformation of the reflection sheet during thermal expansion is avoided.

Moreover, the number of components and structure complexity of the backlight module of the present invention are simplified, and therefore total weight and production cost of the backlight module are reduced. Accordingly, competitiveness of the products applying the backlight module according to an embodiment of the present invention is improved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a back plate;
a reflection sheet, disposed on the back plate, wherein one end of the reflection sheet is bent to form a lamp reflector;
a light guiding plate, disposed on the reflection sheet, wherein the light guiding plate has a first side and a corresponding second side, and a first containing space is formed between the first side of the light guiding plate and the lamp reflector;
a reflector, disposed on the second side of the light guiding plate, wherein a second containing space is formed between the second side of the light guiding plate and the reflector, and the reflector and the reflection sheet are separable;
a first light source, disposed in the first containing space; and
a second light source, disposed in the second containing space.

2. The backlight module as claimed in claim 1 further comprising a frame disposed on the back plate, wherein the frame has an opening to expose the light guiding plate.

3. The backlight module as claimed in claim 1 further comprising an optical film set disposed on the light guiding plate.

4. The backlight module as claimed in claim 3, wherein the optical film set comprises at least one of a diffuser film, a prism sheet and a brightness enhancement film.

5. The backlight module as claimed in claim 1, wherein the reflector is composed of a metal substrate and a reflective material layer disposed on the surface of the metal substrate.

6. The backlight module as claimed in claim 1, wherein the first light source comprises a cold cathode fluorescent lamp or a light emitting diode array.

7. The backlight module as claimed in claim 1, wherein the second light source comprises a cold cathode fluorescent lamp or a light emitting diode array.

8. The backlight module as claimed in claim 1, wherein the second containing space comprises an expansion space.
